(19) United States
(12) Patent Application Publication
(10) Pub. No.: US 2003/0096535 A1
(43) Pub. Date: May 22, 2003

(54) Power block

(76) Inventor: Donald J. E. Miller JR., Tampa, FL (US)

Correspondence Address: Donald J. E. Miller, Jr., 6509 Secrest Ct, Tampa, FL, 33625, US

(21) Appl. No.: 09/973,542

(22) Filed: Oct. 9, 2001

(51) Int. Cl. H01R 25/00

(52) U.S. Cl. 439/652

(57) ABSTRACT

Power Block is an ac adapter with a nightlight, air freshener and chemical light block. It has rocker switches that turn off and on the plugs located on the power strips or on the block itself. The power strips have eight plugs and two telephone connectors, and power block has surge protection.

### SPECIFICATION

The POWER BLOCK is an ac adapter that plugs into the wall socket, or uses a extension cord that is built in, and power block will have four versions, three versions use power strips. The power strips will have eight plugs on each, three plugs on each strip will be spaced one and a half inches apart, and five plugs will be spaced a half inch apart and one version of the power block will have no power strips at all. There is a rubber strip on the bottom of the block that glows in the dark so power block can be found if the electricity goes out. This strip is replaceable if the glow fades; there is a non-glow strip also. Power Block will have three screws at the top bottom and center of the block so it can be screwed on to the wall panel for extra security, and Power Block will have surge protection. The power blocks that don't plug into the wall and use a cord will have a slit in the back and will come with a bracket, so it can be mounted on a shelf, side panel or wall.

Power Block will have a nightlight built in. The light will be square and the back corners will be rounded and the back will be flat and flat on top and bottom, with one spike on each side that plugs into the block. The light bulb will be built into the nightlight and have a slit on each side plus top and bottom, so the light can be pulled out and replaced. The plastic cover on the light will be in color in order to give a soft glow. There will be a switch to turn the nightlight off and on. The light will be located center top of the block.

There will be an air freshener also built in, and can be replaced. The freshener holder will be clear and will be octoangular shaped. The holder will have slits in it so the fragrance can come through. Power Block will have four slots on it so the slots on the holder can be pushed in, turned and locked in place. The locking part on the holder is round. The air freshener will be located middle center under the nightlight on the block.

Rocker switches will be on power block to turn the plugs on the block or power strips off and on. A version of power block will have a rocker switch that will turn off six of the plugs on the power strip, for those with computer systems. These switches will be in two columns and eight rows or two columns with three switches in the first row and eight switches in the second row, or in one column and five rows or one column and eight rows. There will be between one to five plugs and/or switches on power block for convenience depending on the version. Switches are located on the right side of the block and the plug(s) are under the air freshener or on the right side of the air freshener and nightlight, plus the switches and plugs are numbered.

A light block is also part of the power block. This light block is rectangle in length and rectangle in width, and has a clip on the back so it can be clipped on a pocket or strap. It has a strip on the end with a hook and a hole to tie a string through it or hook on a line. The light block will light up when the chemicals inside are mixed together, and will last up to twelve hours. Light block is located in a slot on the left side of the block.

### BACKGROUND

1. Field

This invention relates to wall plug adapters.

2. Information

Power Block eases the problem of buying ac adapters, extension cords and power strips to increase needed power source, and you don't need a nightlight or air freshener because all those items are in this adapter. It also keeps the plugs from being taken up by night-lights and air fresheners. It also solves the problem of having to unplug items from behind obstacles, such as an entertainment center or a desk if the weather is bad because the switches on the power block turn off the items.

### SUMMARY

The power block is an item suited for situations such as, having to unplug items because of bad weather and the plugs are behind a piece of furniture like an entertainment center. In that kind of situation you don't have to unplug the items from the wall or power strip, with the power block all you do is turn them off by a switch on the block. Power Block has a switch for each plug on the connecting strips, so items can be turned off when not in use and others left on if needed. And power block has surge protection, plus the switches and plugs are numbered to tell what switch works which plug. And since there's a night light and air freshener built in to the power block none of the plugs on the block or its power strips will be taken up by these items.

One version of power block will have two power strips with varies cord lengths, so one strip can be used at the right side of the room while the other strip is used at the left side of the room. Power Block can be plugged into the wall and items can be turned off and on by the switches on the block. Power block can plug directly into the wall or can have an electrical cord to it, so if the wall outlet and the power strip are both behind the same obstacle, items can be turned off at the block. The power block comes with a chemical light called light block, and it can be used in emergency like power outage; it glows up to twelve hours and is waterproof.

### DESCRIPTION OF DRAWINGS

1. Shows versions 1 and 2 of power block.

2. Shows versions 3 and 4 of power block.

3. Shows different views of power block and its support bracket.

4. Shows nightlight and air freshener, plus fragrance holder.

5. Shows light block and glow strip.

6. Shows the power strips.

### DESCRIPTION OF INVENTION

The Power Block is surge protected and made of plastic with versions 1, 2 and 3 measuring approximately 1 ½″D/6 ¼″L/5 ½″W, and version 4 approximately 1 ½″D/6 ¼″L/4 ½″W, and the top and bottom of the blocks will slant from the front up to the back approximately 10 degree angle. And the power block can plug into the wall direct or by electric cord that comes in various lengths. The versions of power block that use a cord will have a slit in the back of the block and will come with a bracket so the block can be mounted on a shelf or side panel. The rocker switches in version one are in two columns and eight rows, in version two they are in two columns with three rows in the first column and eight rows in the second column. And in version three the rocker switches are in one column and five rows. Version Four is the same as 1 and 2 but it has one column and eight rows. In versions 1, 2 and 4 switches and plugs can be numbered to tell what switch works which plug, the rocker switches are approximately 1″L/½″W. The nightlight will be approximately 1 ½″L/1 ½″W/1″D, with the light bulb built into the nightlight and will be in the top center of the block. The head of the nightlight is square, and the body is flat on top and bottom and the sides are flat, the side back corners of the body are round and the back is flat and has two rods sticking out the back on both sides that plug into the block. There is a switch under the nightlight so it can be turned off and on, and all 4 versions of power block will have the nightlight. The air freshener holder will be made of clear plastic and the top is octoangular shaped, and it will measure from corner to corner approximately 2″W/1″D. The body of the holder will be round with four strips on four sides of the body that will slide and lock into slots on the block. In the center of the holder inside is the holder for the fragrance cup, also octoangular shaped. There are slits in the top of the holder for the smell to escape from. The fragrance cup is made of a thin plastic that fits into the holder. The air freshener is located in the middle of the block the air freshener will be on all blocks. The power block, nightlight, air freshener fregrince, glow strip and light block will come in veriase colors.

Version 1, 2 and 4 of power block will have one outlet located at the bottom center of the block right under the air freshener, version 3 will have five outlets located at the right side of the block next to the five rocker switches. On the left side of the block is a trench that sinks approximately ½″ into the block, and has two panels on each side and a slot across the top of the trench. Light block is made of plastic that is flexible so when it is bent the two chemicals inside mix and glow, and it has a clip on the back. And at the bottom is a strip with a hook and a hole if needed, and the light measures approximately 5″L/1″W/½″D and fits in the trench on the power block. There is a strip at the bottom of the block which glows in the dark, and it is approximately 4″L/¼″W/⅜″D and if not needed then there is another strip that doesn't glow, these items are on all versions of power block.

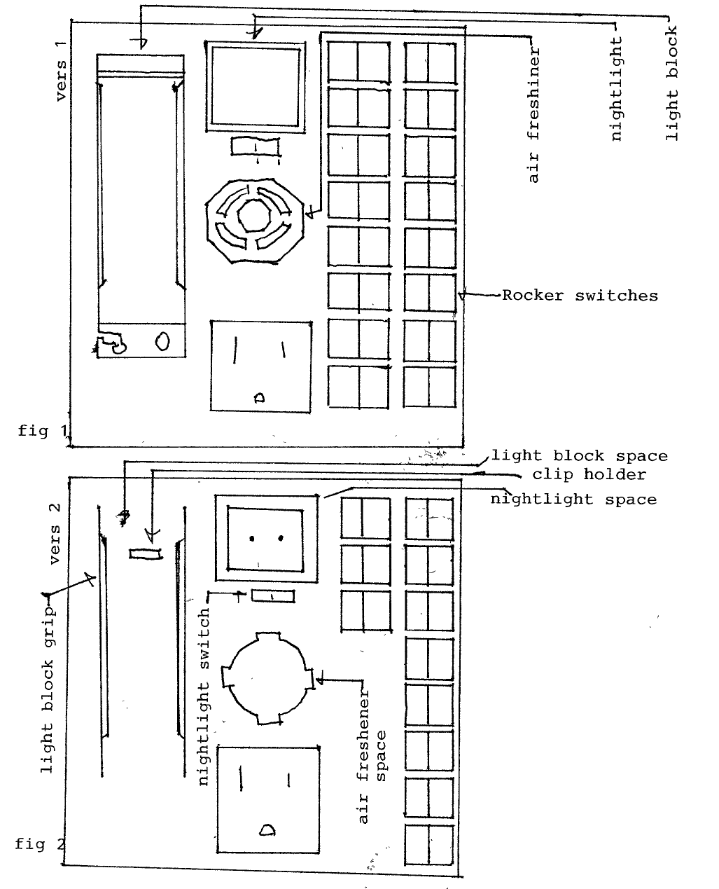

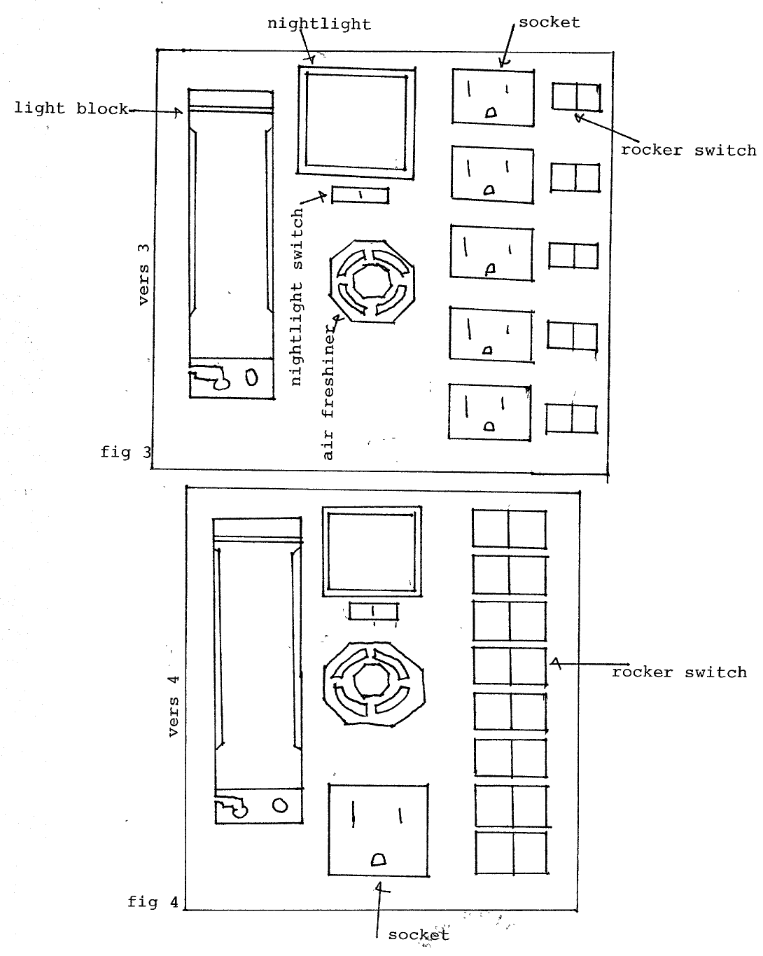

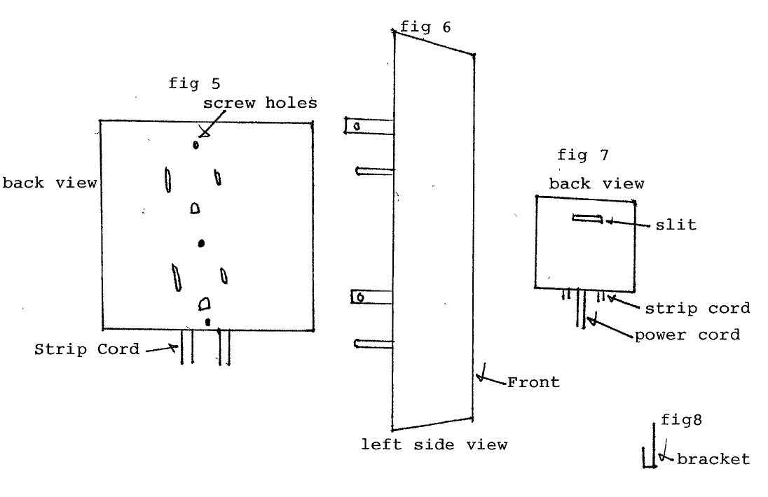

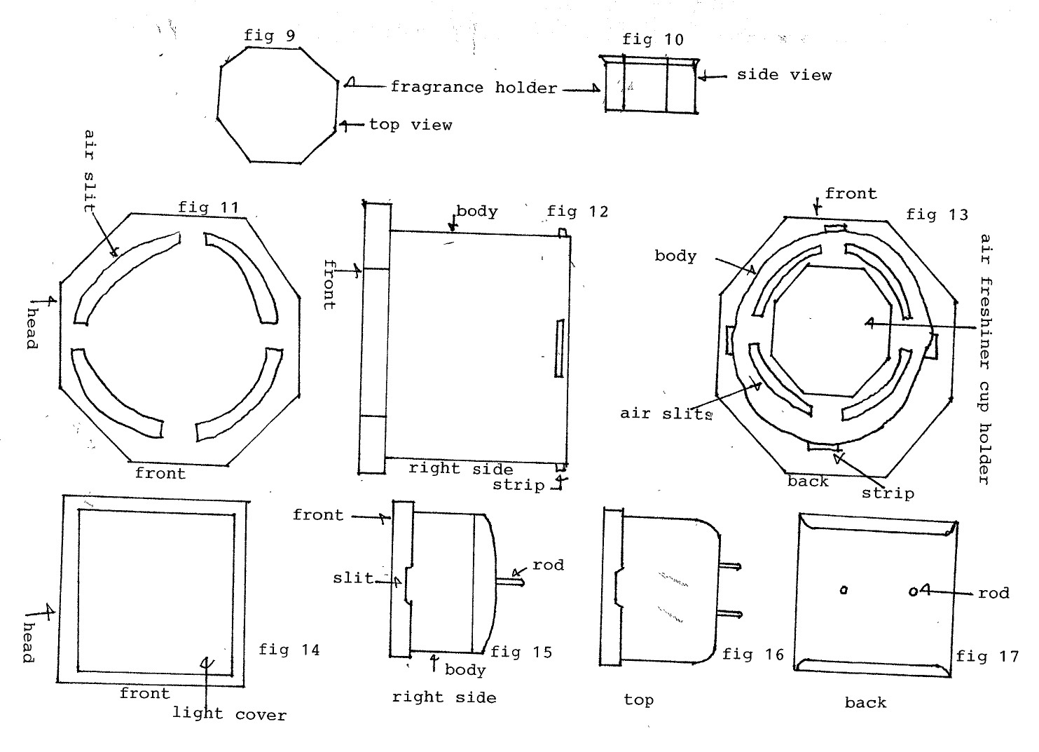

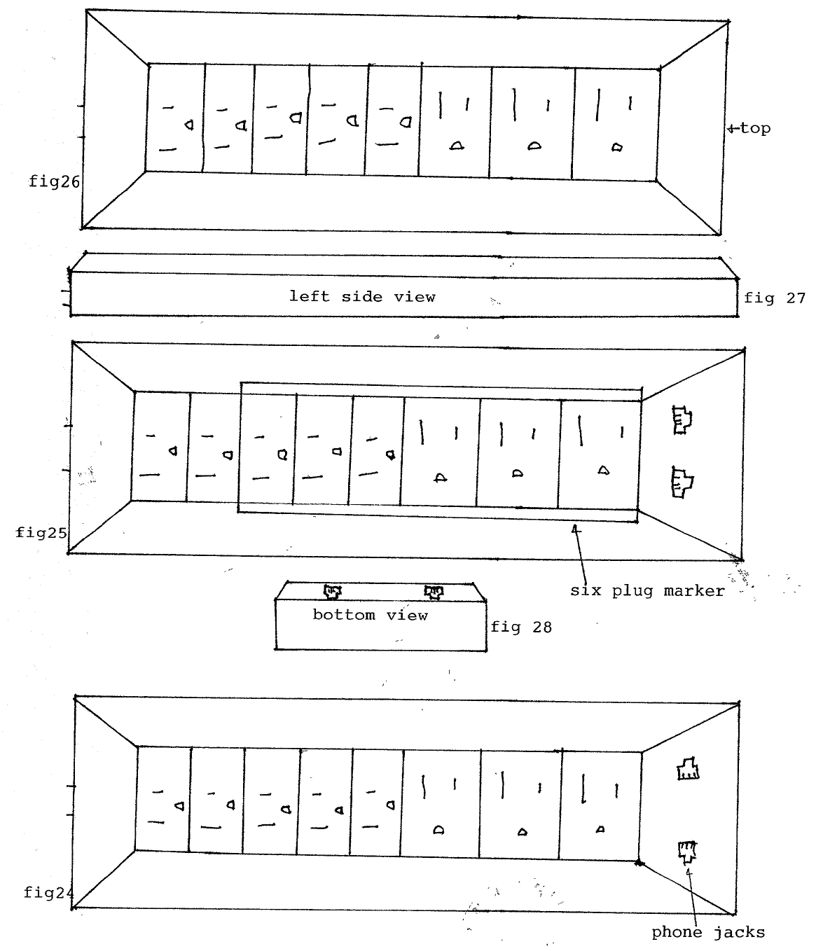

There are three figures of power strip, all three figures measure approximately 18 ½″L/3″W/1 ½″D and will have eight plug on them. Five plugs are ½″ apart and three plugs are 1 ½″ apart, and two of the power strips will have telephone connecters. In FIG. 1 all plugs can be turned off by a separate switch on the power block, in FIG. 25 the first two plugs on the power strip can be turned off by a separate switch on the block and the other six plugs are marked in color and are turned off by one switch on the block and it to comes with telephone connecters. And FIG. 26 is the same as FIG. 24 but it doesn't have the phone connecters.

Version one of power block comes with FIG. 24 and FIG. 26 of power strip, and version two comes with FIG. 25 and FIG. 26 of power strip. The fourth version of power block will come with FIG. 24 or FIG. 25 of power strip.

01. I claim power block, as described herein specifications and in the drawings, an ac adapter that has surge protection, and plugs into the wall directly or by cord. With numbered rocker switches that you can turn the plugs on the block or on the numbered power strips off and on without having to unplug items. With a nightlight and a switch to turn the nightlight off and on. And the octoangular air freshener holder and fragrance, plus the chemical light block with the clip on the back, with hook and hole on the bottom strip across from each other and not top and bottom, and the rubber glow strip and non-glow strip. Plus the power strip with phone jacks and marked plugs.

02. I claim power block of claim 01, wherein said nightlight with built in light bulb and a switch to turn the nightlight off and on.

03. I claim power block of claim 01, wherein said octoangular air freshener holder.

04. I claim power block of claim 03, including octoangular fragrance and fragrance cup.

05. I claim power block of claim 01, wherein said chemical light block with its clip on the back, plus hook and hole across from one another.

06. I claim power block of claim 01, wherein said glow strip and non-glow strip.

07. I claim power block of claim 01, wherein said numbered power strips with phone connectors and marked plugs.
